(19) United States
(12) Patent Application Publication
(10) Pub. No.: US 2013/0262319 A1
(43) Pub. Date: Oct. 3, 2013

(54) Do it yourself elearning personal learning environment (PLErify) business model

(71) Applicant: Maria Lorna Kunnath, Davis, CA (US)

(72) Inventor: Maria Lorna Kunnath, Davis, CA (US)

(21) Appl. No.: 13/403,621

(22) Filed: Mar. 13, 2012

(51) Int. Cl. G06Q 10/10

(52) U.S. Cl. CPC G06Q 10/103
USPC 705/301

(57) ABSTRACT

The PLErify Tool is a major step in simplifying what was once a tedious process in helping professionals be self-reliant in curating, mashing and spreading digital content. The PLErify Tool also removes the barriers to understanding and harnessing the enormous power of being creative yet be completely in control of information sacred to their professions. Not only does the PLErify environment allows professionals to have complete ownership of what they create, it also allows this group of professionals to develop the skill of refining their ability to select tools that best allow them to express themselves so critical to making decisions on what to disseminate and, at what level of confidentiality vis a vis the course objectives deemed most comfortable to both the disseminator and the audience. This aspect is so important to preserving and keeping specifics to an appropriate level particularly where level of confidentiality and self expression sometimes collide. Through the constant use of these tools, a faculty managing and preserving their areas of specialization eventually develops their own way digital teaching style as if they were in traditional classrooms.

### STATEMENT OF FEDERALLY SPONSORED RESEARCH/DEVELOPMENT (IF ANY)

none

### BACKGROUND OF THE INVENTION

This invention came about as a result of the Inventor's (Dr. Maria Lorna A. Kunnath) extenuating experience as a lone elearning developer contracted to complete two elearning projects for the University of California Davis Health System UCDHS during the period 2005-2007. These kinds of projects are normally done within an Instructional Design Team in an organization or if unavailable contracted out to an outside body requiring a group team effort usually at a much higher cost. Having commissioned a single individual to perform both tasks saved the University of California the huge cost. These projects were the Telemedicine Graduate Course for the Medical Informatics group and, the Rapid Prototype Pandemic Flu course for Emergency Personnel for the Center for Health and Technology.

Faced with an absence of personnel to assist her from research (gathering of content) to accumulation of media assets and incorporating these assets within the course syllabus in the first project, the Inventor recognized and eventually devised a system to make the arduous course creation a much easier process. When tasked with the second project, she followed the same principle and sequenced her work in a more systematic way resulting in lesser time spent to complete the project. After those two solitary assignments and hurdling other obstacles ranging from lack of software/hardware, lack of personnel as previously mentioned, disorganized media library and absence of a reliable Learning Management System, she decided she was going to make the elearning research, design, build, and deployment a clearer more systematic yet affordable and make it more seamless to an already disenfranchised professionals who mostly view the experience as an insurmountable task. Thus came the ‘aha’ moment in her mind to automate the whole process.

In the new system web applications that enabled completing a set of similar tasks and so on and so forth from design to deployment to an LMS will be grouped. The inventor experimented and built a few versions of the prototype from 2007 to prototype the automated PLErify concept and after completing a reasonably functioning version in 2010 decided to offer the service for free to the public. The style used was geared particularly to Professionals (faculty, people in leadership positions, Heads of Companies etc.) who are usually challenged pressed for time and resources to distribute critical knowledge at a moment's notice to a select group of audience.

### REPLACEMENT BRIEF SUMMARY OF THE INVENTION

A Do It Yourself Elearning Personal Learning Environment (PLErify) Business Model which is a collective of web applications, tools and resources sequenced and arranged to construct an elearning project in a systematic and organized way available via a Subscription Model for paid versions and a Freemium Account for the free to the public version.

### REPLACEMENT DESCRIPTION OF THE VIEWS OF THE DRAWING (IF ANY)

### Detailed Description of the Invention

Currently, if a professional wants to create a quick elearning project, put together a digital presentation or a digital narrative, professional/creator will have to scour own desktop to search/test/build files from a personal collection (desktop-based) of software or, browse the web for cloud-based web apps to create and mash content. The PLErify tool solves the tedious issue surrounding elearning construction of having the right mix of web applications handy and ready to use at a moment's notice. To build an elearning project, a professional/creator begins by utilizing pre-existing content. With that as a starting point, professional/creator then enlarges scope of content by adding reliable and valid content through PLErify Research Tools.

These content could consist of datasets, facts and figures, factual data, narratives from articles, collections of ideas, concepts and theories from reliable sources and live databases. If datasets need further analysis then professional/creator works through it throug Data Analytic Set. Through PLErify Media Resources professional/creator can add supportive media and enhance/revise those media through PLErify Media Modification Tools. Once professional/creator is ready to build and organize content as a coherent digital project he/she inputs the elearning project in two ways:
1- straight to a choice of an LMS (efront, moodle, atutor) and,
2- 2-within a Course Authoring Platform for further refinement unique to an LMS (i.e. ATutor has an authoring tool called AContent) and delivered as a packaged course in that same LMS.

Both methods will produce a unique URL link in the LMS that is then sent to select group of trainees/students registered to view the course.

A Working Prototype available at http://elearnovate.org/myaccount

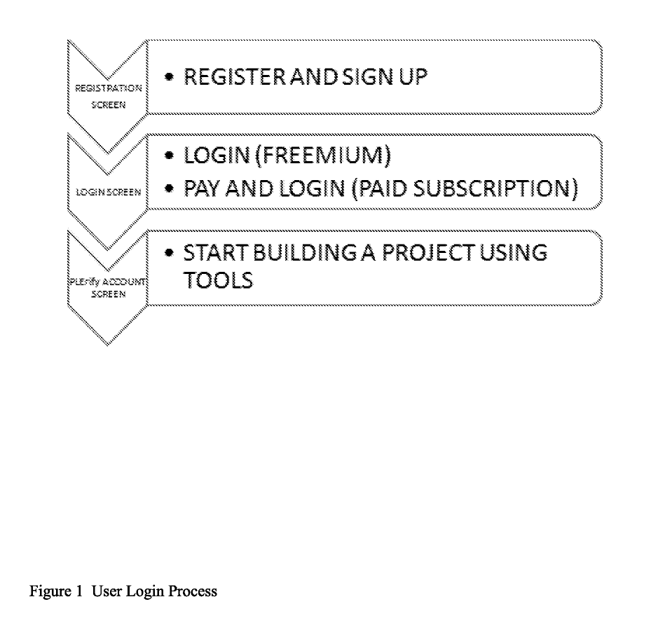

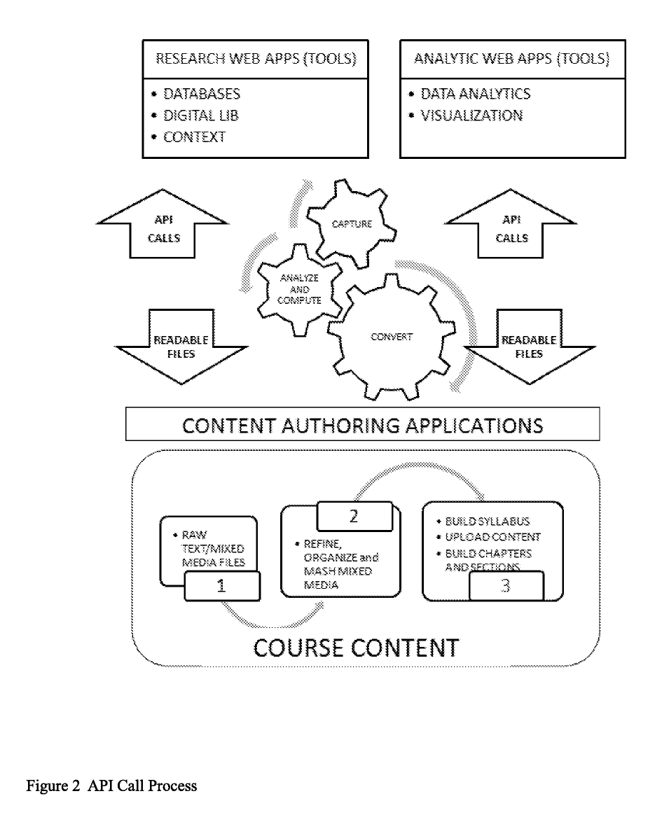

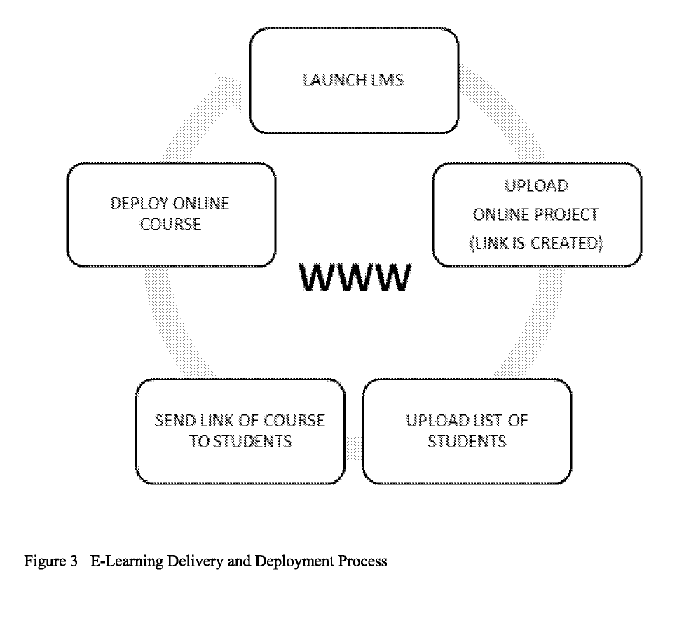

The PLErify Business Model follows the systematic steps which based on member level of proficiency may repeat steps 4, 5, 6 and 7 in a manner comfortable to the professional.
1 User subscribes by paying a fee (FIG. 1)
2 Based on the plan a user selects a Basic or Advanced (web software applications) set of Tools become visible according to chosen plan.
3 The visible tools are ready to use immediately (in technical terms, through a series of access to these tools (i.e. API calls invoked by user to these applications), data is returned to the user. (FIG. 2)
4 To start building content, user may begin extracting data from the live datasets available in real time for any user's purpose from each site e.g. demographic data from the census site of number of college graduates from year 2000 to year 2010.
5 Same data can be analyzed using my set of Analytic Tools, get the results and get the information
6 User needing additional multimedia resources for a project can proceed to pull these from the Media Resources Tools
7 User proceeds to the Authoring Set of Tools to start mashing content using a syllabus builder. One of the tools in this set is a flash publication platform where synchronized presentation can be built
8 Once the above is complete and in final shape, user can then proceed to publish the project (presentation, etraining, elearning) in a Learning Management System (FIG. 3)

### System Requirements

1. Cloud Providers
2. Web Applications
3. Company Relationship with some Web Application Providers (Partner/Affliate/Reseller)
   i. User only needs a video and graphics preferably flash-ready PC/Mac and a PLErify Subscription Plan (Basic/Advanced)

Each step or each set of tools provide a certain function and is not related to the other set of tools. However, each set provides a function that the other sets cannot provide. For example the data (numbers) from the live datasets are mere numbers however, if you want to look at the trends of the numbers you move to the Data Analytic Tools and do some number crunching e.g. correlations, trends and relationships etc. and extract a different set of numbers and explanation for those findings which you can now incorporate in your presentation, etraining, elearning project.

For each Subscription (basic/advanced) a user gets access to a set of tools. However, more tools are available for the advanced subscriber. API's and Web Accounts have been obtained by MLAKedusoln eLearnovate as a result of professional relationships established with partnering companies as well as other elearning related solution providers. Thus, the Inventor is able to integrate these varying set of solutions within the total PLErify ecosystem accordingly. Determining the appropriate fit is a matter of experience and familiarity with the app's utility and function in relation to the PLErify business concept. The Research and Knowledgebase Toolsets selected are geared for use by the higher education group, the corporate group and the industry specific group which are the PLErify Tool's main target users.

1. The current practice usually involves a team of people contributing a unique skillset to to build on the media object creation, instructional design and content creation.

2. With the PLErify tool it is now possible to replicate or augment the skillset of many in a single individual provided the individual possess the ability to conceptualize an idea and build on that idea with the goal to transmitting the idea digitally. For the C-Level executive there is always a need to transmit mission-critical knowledge that are best captured within the confines of certain level of confidentiality and transmitted only to few select decision-makers.

3. The current approach is quite a scattered process involving sign-ups to several services, tools and resources which can become expensive and unmanageable.

4. The current elearning construction process does not follow a coherent scheme with desktop-reliant professionals leaving out easy to use but very unfamiliar web applications that are not only cheaper but less archaic, faster and intuitive.

5. The web is not organized to group certain tools and applications that perform similar functions. Professionals have to do own searching, researching, testing and evaluation to see what works vs. what doesn't work.

6. The business process removes the very time-consuming, cumbersome and confusing process of search, evaluation and selection (of desktop & web apps, resources and tools) to arrive at a single solution to complete an elearning project.

7. The DIY method is, not only the cheapest way but also the most feasible way to combine a host of applications to build unique set or sets of digital learning projects at a fraction of usual cost of designing, creating and building instructionally sound projects.

8. A Do It Yourself (PLErify Tool) Elearning Business Model which is a collective of web applications via a freemium and a paid subscription account for professionals to construct an elearning project.

9. The final product of using the PLErify tool is a multimedia enhanced E-training, Elearning Course or a content-packed Presentation that's accessible anywhere and anytime with a URL link.

10. Sample of a project completed using the concept is viewable at:
http://elearnovate.com/index.php?option=com_wrapper&view=wrapper&Itemid=620

11. The single unique by-product of the organized process is a completed ELearning Project packaged in a Learning Management System constructed within a single portal account containing all tools and resources.

12. A working prototype is available for public use at http://elearnovate.org/myaccount
